(19) United States
(12) Patent Application Publication
(10) Pub. No.: US 2014/0044764 A1
(43) Pub. Date: Feb. 13, 2014

(54) USE OF 2,3,3,3-TETRAFLUOROPROPENE/VINYLIDENE FLUORIDE COPOLYMERS TO PREVENT BIOFOULING

(71) Applicant: HONEYWELL INTERNATIONAL INC., Morristown, NJ (US)

(72) Inventors: Changqing Lu, Snyder, NY (US); Andrew J. Poss, Kenmore, NY (US); Rajiv R. Singh, Getzville, NY (US); David Nalewajek, West Seneca, NY (US); Cheryl Cantlon, Clarence Center, NY (US)

(73) Assignee: HONEYWELL INTERNATIONAL INC., Morristown, NJ (US)

(21) Appl. No.: 13/789,389

(22) Filed: Mar. 7, 2013

Related U.S. Application Data
(60) Provisional application No. 61/681,275, filed on Aug. 9, 2012.

(51) Int. Cl. A01N 29/02

(52) U.S. Cl. CPC A01N 29/02
USPC 424/405; 424/78.09; 526/255

(57) ABSTRACT

A copolymer comprising 2,3,3,3-tetrafluoropropene and vinylidene fluoride and having a surface energy of between about 20 and about 30 mJ/m². A process of preparing a surface having a surface energy of between about 20 and about 30 mJ/m², comprising a step of applying said copolymer to a support. A method of preventing biofouling on an article of manufacture comprising applying said copolymer to the article of manufacture. An article of manufacture that is at least partly covered with said copolymer.

### CROSS REFERENCE TO RELATED APPLICATION

The present application claims priority under 35 U.S.C. § 119(e) to U.S. Provisional Patent Application No. 61/681,275, filed on Aug. 9, 2012, the disclosure of which is incorporated herein by reference in its entirety.

### FIELD OF THE INVENTION

The present technology relates to methods and articles of manufacture for the prevention of biofouling.

### BACKGROUND OF THE INVENTION

Biofouling is any non-desirable accumulation and growth of living matter on wetted surfaces. It is a significant, world-wide problem in almost every industry that relies on water-based processes. Industries particularly affected by biofouling include the pulp and paper manufacturing industry and the food industry, as well as industries connected to underwater construction, ship building, fish farming and water desalination, to name just a few.

One approach to prevent biofouling is the use of non-toxic coatings that create hydrophobic surfaces to which microorganisms cannot attach. Fluoropolymers are generally considered useful with respect to preventing biofouling because of their non-stick and friction reducing properties.

Research has shown that the optimal surface energy for resistance to biofouling in marine environments is always between 20 and 30 mJ/m². See J Mater Sci: Mater Med (2006) 17:1057-1062. So far, few fluoropolymers have been shown to produce this particular surface energy range. For example, on one hand, poly(tetrafluoroethylene) (PTFE), poly(hexafluoropropylene) (PHFP), and poly(2,3,3,3-tetrafluoropropene) (poly-1234yf) have a surface energy below 20 mJ/m²; on the other hand, the surface energy of polyvinylidene fluoride (PVDF) and polychlorotrifluoroethylene (PCTFE) is around 30 mJ/m². Only one fluoropolymer, polytrifluoroethylene (PTrFE), was reported to have a surface energy within the range of 20 to 30 mJ/m².

There remains a need for improved methods and articles of manufacture for the prevention of biofouling. The present invention addresses this need.

### SUMMARY OF THE INVENTION

The present invention provides a method of preventing biofouling on an article of manufacture, comprising applying a copolymer to the article of manufacture, wherein the copolymer comprises 2,3,3,3-tetrafluoropropene and vinylidene fluoride.

In certain embodiments of the present invention, the copolymer has a surface energy of between about 20 and about 30 mJ/m².

The present invention also provides a process of preparing a surface having a surface energy of between about 20 and about 30 mJ/m², comprising a step of applying a copolymer to a support, wherein the copolymer comprises 2,3,3,3-tetrafluoropropene and vinylidene fluoride.

The present invention also provides an article of manufacture that is at least partly covered with a copolymer that comprises 2,3,3,3-tetrafluoropropene and vinylidene fluoride and that has a surface energy of between about 20 and about 30 mJ/m².

The present invention also provides a copolymer, comprising 2,3,3,3-tetrafluoropropene and vinylidene fluoride and having a surface energy of between about 20 and about 30 mJ/m².

In certain embodiments of the present invention, the copolymer consists essentially of 2,3,3,3-tetrafluoropropene and vinylidene fluoride.

In other embodiments of the present invention, the article of manufacture is selected from the group consisting of a ship, a boat, a submarine, an undersea cable, an offshore drilling platform, and a bridge.

In other embodiments of the present invention, the article of manufacture is at least partly submerged in water.

In certain embodiments of the present invention, the copolymer is incorporated or blended into a coating to provide a low energy coating to the article of manufacture.

In certain embodiments of the present invention, the copolymer is attached to the article of manufacture by way of a surface treatment of the article or by way of priming the surface of the article to promote adhesion.

### DETAILED DESCRIPTION OF THE INVENTION

The inventors have found that copolymers comprising certain ratios of 2,3,3,3-tetrafluoropropene monomer units and vinylidene fluoride monomer units have a surface energy of between about 20 and about 30 mJ/m² and that the specific surface energy can be controlled by the specific ratio of the 2,3,3,3-tetrafluoropropene monomer units and vinylidene fluoride monomer units in the copolymer. These findings are further set forth in detail in the Examples below. Surfaces having a surface energy within this range are resistant to biofouling. See J Mater Sci: Mater Med (2006) 17:1057-1062.

The present invention provides a method of preventing biofouling on an article of manufacture, comprising applying a copolymer to the article of manufacture, wherein the copolymer comprises 2,3,3,3-tetrafluoropropene and vinylidene fluoride.

The present invention also provides a process of preparing a surface having a surface energy of between about 20 and about 30 mJ/m², comprising a step of applying a copolymer to a support, wherein the copolymer comprises 2,3,3,3-tetrafluoropropene and vinylidene fluoride.

The present invention also provides an article of manufacture that is at least partly covered with a copolymer that comprises 2,3,3,3-tetrafluoropropene and vinylidene fluoride and that has a surface energy of between about 20 and about 30 mJ/m².

The present invention also provides a copolymer, comprising 2,3,3,3-tetrafluoropropene and vinylidene fluoride and having a surface energy of between about 20 and about 30 mJ/m².

Such copolymers may be prepared by any of the numerous methods known in the art. In a non-limiting example, high molecular weight 2,3,3,3-tetrafluoropropene/vinylidene fluoride copolymers are prepared by aqueous emulsion polymerization, using at least one water soluble radical initiator.

The water soluble radical initiators may include any compounds that provide free radical building blocks for the copolymerization of 2,3,3,3-tetrafluoropropene and vinylidene fluoride monomers. Non-limiting examples of such initiators include Na₂S₂O₈, K₂S₂O₈, (NH₄)₂S₂O₈, Fe₂(S₂O₈)₃, (NH₄)₂S₂O₈/Na₂S₂O₅, (NH₄)₂S₂O₈/FeSO₄, (NH₄)₂S₂O₈/Na₂S₂O₅/FeSO₄, and the like, as well as combinations thereof.

The copolymerization of 2,3,3,3-tetrafluoropropene and vinylidene fluoride monomers may be conducted in any aqueous emulsion solutions, particularly aqueous emulsion solutions that can be used in conjunction with a free radical polymerization reaction. Such aqueous emulsion solutions may include, but are not limited to include, degassed deionized water, buffer compounds (such as, but not limited to, Na₂HPO₄/NaH₂PO₄), and an emulsifier (such as, but not limited to, C₇F₁₅CO₂NH₄, CH₃(CH₂)₁₁OSO₃Na, C₁₂H₂₅ C₆H₄SO₃Na, C₉H₁₉C₆H₄O(C₂H₄O)₁₀H, or the like).

The copolymerization is typically carried out at a temperature, pressure and length of time sufficient to produce the desired 2,3,3,3-tetrafluoropropene/vinylidene fluoride copolymers and may be performed in any reactor known for such purposes, such as, but not limited to, an autoclave reactor.

In certain embodiments of the present invention, the copolymerization is carried out at a temperature from about 10° C. to about 100° C. and at a pressure from about 50 psi to about 1,000 psi. The copolymerization may be conducted for any length of time that achieves the desired level of copolymerization. In certain embodiments of the present invention, the copolymerization may be conducted for a time that is from about 24 hours to about 200 hours. One of skill in the art will appreciate that such conditions may be modified or varied based upon the desired conversion rate and the desired molecular weight of the resulting 2,3,3,3-tetrafluoropropene/vinylidene fluoride copolymers.

The relative and absolute amounts of 2,3,3,3-tetrafluoropropene monomers and vinylidene fluoride monomers and the amounts of initiator may be provided to control the conversion rate of the copolymer produced and/or the molecular weight range of the copolymer produced. Generally, though not exclusively, the radical initiator is provided at a concentration of less than 1 weight percent based on the weight of all the monomers in the copolymerization reaction.

The initiator may be added into the copolymerization system multiple times to obtain the desired copolymerization yield. Generally, though not exclusively, the initiator is added 1 to 3 times into the copolymerization system.

The following U.S. patents and patent publications further describe the copolymerization of 2,3,3,3-tetrafluoropropene and vinylidene fluoride and are incorporated herein by reference in their entirety: U.S. Pat. Nos. 2,970,988 and 3,085,996 and U.S. Patent Publication Nos. 2008/0153977, 2008/0153978, 2008/0171844, and 2011/0097529.

The surface energy of the copolymers of the present invention is determined by water and diiodomethane contact angle measurements, which is a method well known in the art.

Copolymers comprising 2,3,3,3-tetrafluoropropene and vinylidene fluoride can be applied to a support or article of manufacture in any of the many ways generally known in the art. In a non-limiting example, the copolymer is dissolved as described in the Examples below and the copolymer solution applied to a support or article of manufacture and then dried.

The copolymers can be incorporated or blended into a coating such as an acrylic or epoxy resins and the fluoropolymer “blooms” to the surface of the coating giving it a low surface energy.

In certain embodiments of the present invention, the copolymer consists essentially of 2,3,3,3-tetrafluoropropene and vinylidene fluoride. In other embodiments of the present invention, the copolymer has a surface energy of between about 20 and about 30 mJ/m². In other embodiments of the present invention, the copolymer has a surface energy of between about 20 and about 25, or of between about 25 and about 30 mJ/m². In other embodiments of the present invention, the article of manufacture is selected from the group consisting of a ship, a boat, a submarine, an undersea cable, an offshore drilling platform, and a bridge. In even other embodiments of the present invention, the article of manufacture is at least partly submerged in water. In even other embodiments of the present invention, the article of manufacture is at least substantially submerged in water.

In certain embodiments of the present invention, the ratio of 2,3,3,3-tetrafluoropropene monomer units versus vinylidene fluoride monomer units in the copolymer of the present invention is from about 90:10 mol % to about 10:90 mol %. In certain embodiments of the present invention, the ratio of 2,3,3,3-tetrafluoropropene monomer units versus vinylidene fluoride monomer units in the copolymer of the present invention is from about 90:10 mol % to about 70:30 mol %, from about 70:30 mol % to about 50:50 mol %, from about 50:50 mol % to about 30:70 mol %, and from about 30:70 mol % to about 10:90 mol %.

Articles of manufacture within the scope of the present invention can be any man-made objects prone to biofouling because they are regularly or permanently exposed to or submerged in water. Non-limiting examples of such articles of manufacture are any kind of boats or ships or submarines, machinery or equipment used in or near water, bridges, offshore drilling platforms, and undersea cables.

To protect the article of manufacture, the copolymer can be attached by way of a prebound surface treatment such as a chemical pretreatment with a silane to promote adhesion or oxidative treatment with zinc phosphate (or titanium or zirconium salts). It may be necessary to treat the surface with a primer to promote adhesion.

The following examples further illustrate the invention, but should not be construed to limit the scope of the invention in any way.

### EXAMPLES

### Example 1

Into 100 mL of degassed deionized water with stirring, 2.112 g of Na₂HPO₄·7H₂O, 0.574 g of NaH₂PO₄, and 2.014 g of C₇F₁₅CO₂NH₄ were added. 0.3068 g of (NH₄)₂S₂O₈ was added into above aqueous solution with stirring and nitrogen bubbling. The obtained aqueous solution was immediately transferred into an evacuated 300 mL autoclave reactor through a syringe. The reactor was cooled with dry ice while the aqueous solution inside was slowly stirred. When the internal temperature decreased to about 0° C., the transfer of a mixture of 2,3,3,3-tetrafluoropropene (111.3 g) and vinylidene fluoride (11.8 g) was started. At the end of the transfer, the internal temperature was below about −5° C. The dry ice cooling was removed. The autoclave reactor was slowly warmed up by air. The aqueous solution inside was stirred at 500 rpm.

When the internal temperature increased to about 15° C., 0.2942 g of Na₂S₂O₅ dissolved in 5 mL degassed deionized water was pumped into the autoclave reactor. The autoclave reactor was slowly heated up to 35° C. The initial internal pressure was 189 psi.

Over 90 hour polymerization, the stirring became difficult; the temperature drifted to 44° C.; the internal pressure dropped to 162 psi. The heating and stirring were then stopped. The autoclave reactor was cooled down by air. At room temperature, the residual pressure was slowly released. The white solid polymer precipitate surrounding the stirrer was taken out and crushed into small pieces. The copolymer was thoroughly washed with deionized water and dried under vacuum (29 in. Hg) at 35° C. to dryness. The dry copolymer weighed 71.3 g to give a yield of 57.9%.

The actual monomer unit ratio in the copolymer determined by ¹⁹F NMR was 91.1 mol % of 2,3,3,3-tetrafluoropropene and 8.9 mol % of vinylidene fluoride. The copolymer was soluble in acetone, THF, and ethyl acetate. The weight average molecular weight of the copolymer measured by GPC included 779,780 (major) and 31,832 (minor). The coating film of the copolymer (by solution casting on aluminum substrate) gave a water contact angle of 96.9°, a diiodomethane contact angle of 77.2°, and the corresponding surface energy of 21.6 mJ/m².

### Example 2

Into 100 mL of degassed deionized water with stirring, 2.112 g of Na₂HPO₄·7H₂O, 0.574 g of NaH₂PO₄, and 2.014 g of C₇F₁₅CO₂NH₄ were added. 0.3018 g of (NH₄)₂S₂O₈ was added into above aqueous solution with stirring and nitrogen bubbling. The obtained aqueous solution was immediately transferred into an evacuated 300 mL autoclave reactor through a syringe. The autoclave reactor was cooled with dry ice and the aqueous solution inside was slowly stirred. When the internal temperature decreased to about 0° C., the transfer of a mixture containing 77.1 g of 2,3,3,3-tetrafluoropropene and 32.3 g of vinylidene fluoride into the autoclave reactor was started. At the end of the transfer, the internal temperature was below about −5° C. The dry ice cooling was removed. The autoclave reactor was slowly warmed up by air. The aqueous solution inside was stirred at 300 rpm.

0.2905 g of Na₂S₂O₅ dissolved in 10 mL degassed deionized water was pumped into the autoclave reactor. The autoclave reactor was slowly heated up to 35° C. A slight exothermic initiation process was observed. The stir rate was increased to 500 rpm. The initial internal pressure was 328 psi.

After 38 hours, the internal pressure dropped to 55 psi. The heating was then stopped. The autoclave reactor was cooled down by air. The stir rate was decreased to 50 rpm. At room temperature, the residual pressure was slowly released. The white solid polymer chunk was taken out and crushed into small pieces. The copolymer was thoroughly washed with deionized water and dried under vacuum (29 in. Hg) at 35° C. to dryness. The dry copolymer weighed 98.3 g to give a yield of 89.9%.

The actual monomer unit ratio in the copolymer determined by ¹⁹F NMR was 63.8 mol % of 2,3,3,3-tetrafluoropropene and 36.2 mol % of vinylidene fluoride. The copolymer was slowly soluble in acetone, THF, and ethyl acetate. The weight average molecular weight of the copolymer measured by GPC was 452,680. The coating film of the copolymer (by solution casting on aluminum substrate) gave a water contact angle of 89.1°, a diiodomethane contact angle of 80.6°, and the corresponding surface energy of 23.3 mJ/m².

### Example 3

Into 100 mL of degassed deionized water with stirring, 2.153 g of Na₂HPO₄·7H₂O, 0.568 g of NaH₂PO₄, and 2.048 g of C₇F₁₅CO₂NH₄ were added. 0.2598 g of (NH₄)₂S₂O₈ was added into above aqueous solution with stirring and nitrogen bubbling. The obtained aqueous solution was immediately transferred into an evacuated 300 mL autoclave reactor through a syringe. The autoclave reactor was cooled with dry ice and the aqueous solution inside was slowly stirred at 50 rpm. When the internal temperature decreased to about −4° C., a mixture containing 47.7 g of 2,3,3,3-tetrafluoropropene and 45.8 g of vinylidene fluoride was transferred into the autoclave reactor. The dry ice cooling was removed. The autoclave reactor was slowly warmed up by air. The aqueous solution inside was stirred at 300 rpm.

When the internal temperature increased to about 0° C., 0.2986 g of Na₂S₂O₅ dissolved in 5 mL degassed deionized water was pumped into the autoclave reactor. The stir rate was increased to 500 rpm. The autoclave reactor was slowly warmed up to room temperature. When the autoclave reactor was slowly heated up to 30° C., an exothermic initiation process was observed. The internal temperature increased to about 38° C. The internal pressure was 609 psi at this time.

Occasionally, the autoclave reactor was cooled with dry ice to control the internal temperature between 34° C. and 36° C.

After 1 hour, the heating was started to maintain the internal temperature at 35° C. After a total of 15 hours, the internal pressure dropped to 62 psi at 35° C. The heating was then stopped. The autoclave reactor was cooled down by air. The stir rate was decreased to 50 rpm. At room temperature, the residual pressure was slowly released. The white solid copolymer precipitate was thoroughly washed with deionized water and dried under vacuum (29 in. Hg) at 35° C. to dryness. The dry copolymer weighed 84.6 g to give a yield of 90.4%.

The actual monomer unit ratio in the copolymer determined by ¹⁹F NMR was 22.1 mol % of 2,3,3,3-tetrafluoropropene and 77.9 mol % of vinylidene fluoride. The copolymer was soluble in DMF, and slowly soluble in acetone, THF, and ethyl acetate. The weight average molecular weight of the copolymer measured by GPC was 534,940. The coating film of the copolymer (by solution casting on aluminum substrate) gave a water contact angle of 79.3°, a diiodomethane contact angle of 84.0°, and the corresponding surface energy of 27.5 mJ/m².

### Example 4

Into 100 mL of degassed deionized water with stirring, 2.146 g of Na₂HPO₄·7H₂O, 0.578 g of NaH₂PO₄, and 2.022 g of C₇F₁₅CO₂NH₄ were added. 0.1552 g of (NH₄)₂S₂O₈ was added into the above aqueous solution with stirring and nitrogen bubbling. The obtained aqueous solution was immediately transferred into an evacuated 300 mL autoclave reactor through a syringe. The autoclave reactor was cooled with dry ice and the aqueous solution inside was slowly stirred. When the internal temperature decreased to about −2° C., the transfer of a mixture of 2,3,3,3-tetrafluoropropene (27.7 g) and vinylidene fluoride (80.1 g) into the autoclave reactor was started. At the end of the transfer, the internal temperature was below about −5° C. The dry ice cooling was removed. The autoclave reactor was slowly warmed up by air. The aqueous solution inside was stirred at 300 rpm.

When the internal temperature increased to about 3° C., 0.1609 g of Na₂S₂O₅ dissolved in 5 mL degassed deionized water was pumped into the autoclave reactor. The autoclave reactor was slowly heated towards 35° C.; meanwhile, the stir rate was increased to 500 rpm. A vigorous exothermic initiation process was observed at about 26° C. The autoclave reactor was periodically cooled with dry ice to maintain the temperature between 26° and 30° C.

After 2 hours, the periodic dry ice cooling was stopped. The internal temperature was about 31° C. The stir rate was decreased to 300 rpm. The corresponding internal pressure was 550 psi. After overnight polymerization at room temperature, the internal temperature of polymerization mixture dropped to 24° C.

The autoclave reactor was then cooled with dry ice. When the internal temperature decreased to about 2° C., 0.1044 g of (NH₄)₂S₂O₈ dissolved in 5 mL of degassed deionized water was pumped into the autoclave reactor, followed by 10 mL of degassed deionized water to rinse the pumping system. 0.1189 g of Na₂S₂O₅ dissolved in 5 mL of degassed deionized water was pumped into the autoclave reactor, followed by 10 mL of degassed deionized water to rinse the pumping system.

The dry ice cooling was removed. The autoclave reactor was warmed up by air. Meanwhile, the stir rate was increased to 500 rpm. The autoclave reactor was then slowly heated to 35° C. The corresponding internal pressure was 555 psi at this time.

After a total of 35 hours of polymerization, the internal pressure decreased to 526 psi. The heating was stopped. The stir rate was decreased to 50 rpm. At room temperature, the residual pressure was slowly released. The copolymer precipitate was taken out and thoroughly washed with deionized water. The copolymer was dried under vacuum (29 in. Hg) at 35° C. to dryness. The dry copolymer weighed 84.9 g to give a yield of 78.7%.

The actual monomer unit ratio in the copolymer determined by ¹⁹F NMR was 29.3 mol % of 2,3,3,3-tetrafluoropropene and 70.7 mol % of vinylidene fluoride. The copolymer is soluble in DMF, and partially soluble in acetone and THF. The copolymer is not soluble in ethyl acetate. The copolymer physically shows the characteristic of an elastomer at room temperature. The weight average molecular weight of the copolymer measured by GPC was 635,720. The membrane made by hot press of the copolymer gave a water contact angle of 79.1°, a diiodomethane contact angle of 80.1°, and the corresponding surface energy of 28.5 mJ/m².

What is claimed is:

1. A method of preventing biofouling on an article of manufacture, comprising applying a copolymer to the article of manufacture, wherein the copolymer comprises 2,3,3,3-tetrafluoropropene and vinylidene fluoride.

2. The method of claim 1, wherein the copolymer consists essentially of 2,3,3,3-tetrafluoropropene and vinylidene fluoride.

3. The method of claim 2, wherein the copolymer has a surface energy of between about 20 and about 30 mJ/m².

4. The method of claim 3, wherein the article of manufacture is selected from the group consisting of a ship, a boat, a submarine, an undersea cable, an offshore drilling platform, and a bridge.

5. A process of preparing a surface having a surface energy of between about 20 and about 30 mJ/m², comprising a step of applying a copolymer to a support, wherein the copolymer comprises 2,3,3,3-tetrafluoropropene and vinylidene fluoride.

6. The process of claim 5, wherein the copolymer consists essentially of 2,3,3,3-tetrafluoropropene and vinylidene fluoride.

7. An article of manufacture that is at least partly covered with a copolymer that comprises 2,3,3,3-tetrafluoropropene and vinylidene fluoride and that has a surface energy of between about 20 and about 30 mJ/m².

8. The article of manufacture of claim 7, wherein the copolymer consists essentially of 2,3,3,3-tetrafluoropropene and vinylidene fluoride.

9. The article of manufacture of claim 8, wherein the article of manufacture is at least partly submerged in water.

10. The article of manufacture of claim 9, selected from the group consisting of a ship, a boat, a submarine, an undersea cable, an offshore drilling platform, and a bridge.

11. A copolymer, comprising 2,3,3,3-tetrafluoropropene and vinylidene fluoride and having a surface energy of between about 20 and about 30 mJ/m².

12. The copolymer of claim 11, consisting essentially of 2,3,3,3-tetrafluoropropene and vinylidene fluoride.

13. The method of claim 1, wherein the copolymer is incorporated or blended into a coating to provide a low energy coating to the article of manufacture.

14. The method of claim 1, wherein the copolymer is attached to the article of manufacture by way of a surface treatment of the article or by way of priming the surface of the article to promote adhesion.
